(19) United States
(12) Patent Application Publication
(10) Pub. No.: US 2025/0185124 A1
(43) Pub. Date: Jun. 5, 2025

(54) INFRARED HEATER

(71) Applicant: Herschel Infrared Ltd

(72) Inventors: Richard MARTIN, Avonmouth (GB); Paul MOREY, Avonmouth (GB)

(21) Appl. No.: 18/963,124

(22) Filed: Nov. 27, 2024

(30) Foreign Application Priority Data
Dec. 4, 2023 (GB) 2318505.1

(51) Int. Cl. H05B 3/00; H01C 7/02; H05B 3/12; H05B 3/26

(52) U.S. Cl. CPC H05B 3/008; H01C 7/02; H05B 3/12; H05B 3/26

(57) ABSTRACT

An infrared heater comprising an infrared emission surface, a rear surface and a plurality of independent heating elements arranged between the heating surface and rear surface, wherein the plurality of independent heating elements operate on independent circuitry such that each heating element can be independently controlled, and wherein the independent heating elements are configured such that the infrared emission surface has an operating temperature of 85° C. to 110° C.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Infrared heaters emit infrared energy to provide radiant warmth to a space without relying on the air within the space to transfer heat between objects. Therefore, infrared heaters can have greater energy transmission efficiency in comparison to conventional electric radiators.

The typical operating mode for such infrared panels involves providing power to the heating elements until the desired temperature has been reached and then removing power to the heating elements when the desired temperature has been reached. As the region around the infrared heater then cools, the ambient temperature falls away from the desired temperature resulting in the heating elements being powered once more. Thus, existing infrared heating systems do not provide a comfortable constant heat and instead cycle through large temperature changes which can be perceptible to humans. This disadvantage is further felt if the operating mode is relying on accurate readings from temperature sensors as there can be a lag between the temperature being reached (and felt by humans) and the temperature being detected, especially if only air temperature sensors are being used. Therefore, there can be high and low temperatures experienced which do not optimise human comfort and energy use.

Therefore, there exists a need for an infrared heating system which provides a more consistent temperature than existing systems such that a human is less likely to perceive temperature fluctuations around the target temperature and energy use can be optimised specifically for this type of heating system.

### SUMMARY

According to a first aspect of the present invention there is provided an infrared heater comprising: an infrared emission surface; a rear surface; and a plurality of independent heating elements arranged between the heating surface and rear surface, wherein the plurality of independent heating elements operate on independent circuitry such that each heating element can be independently controlled, and wherein the independent heating elements are each configured such that the infrared emission surface in the region of a heating element has an operating temperature of 85° C. to 110° C. when the heating element is active.

Therefore, the present invention provides an infrared heating panel which can provide partial power and thus varying heating levels whilst its output always remains radiant when in operation. This is in contrast to known infrared heating panels, which operate with one of more elements wired in a single circuit to produce “full on” or “full off” operating modes. By using independent heating elements (with independent circuitry and controls), the user is able to select various combinations of heating options to produce a more personalised heating system. Moreover, the system can be utilised to maintain a target temperature and comfort level more closely as the difference between the power levels is more gradual and not as stark as either “on” or “off”.

The concept of partial power for infrared heating panels has not previously been considered due to the nature of infrared heaters and how they are controlled. Firstly, for typical heaters (such as gas and electric), partial power is usually provided by use of “dimmers” which can reduce overall power or fuel flow to the heater. These dimmers take the form of either circular dials or “Level I/Level II etc.” switches. However, reducing overall power to the heater also reduces the average temperature of the heaters. This is therefore not suitable for infrared heaters as it can take the heater out of the temperature zone required for producing the correct radiant temperature. Secondly, the typical operation involved in heating a space or region involves running a heater in modulation so that the heater is “fully on” until a target temperature has been met and then “fully off” so that the target temperature is not exceeded. Therefore, there is no use for a heater providing a partial power mode during a heating phase because it is desirable to reach the target temperature as quickly as possible. Therefore, the industry has not considered a partial power mode to be necessary and have overlooked its comfort and energy saving benefits.

The plurality of independent heating elements can be configured to operate concurrently and/or individually while each individually outputting the correct temperature to produce infrared heat.

This is advantageous as it provides further levels of heating power in comparison to known infrared heating systems which are modular, i.e., the heating elements are either fully on or fully off. The infrared heater can have two heating elements. The first heating element can be arranged to output less heating power than a second heating element. This results in an infrared heating panel with up to three levels of heating, one from each heating element and a further level when both elements are powered.

The heating surface can comprise an outward facing surface formed at least partially of steel.

This is advantageous as steel provides an acceptable balance between an efficient emitter and conductor. The outer surface of the infrared panel which is intended to face the space to be heated must be able to emit infrared energy efficiently so that heat is taken away from the infrared heater and towards objects in the space. However, the outer surface of a partial power infrared heater must maintain the heat in the area of the heater which is activated so that each heating “zone” keeps its temperature (which is important in order for the correct emission of infrared heat).

Typically, infrared heating panels have an aluminium surface, which is a marginally better emitter than steel, however it also conducts over the surface more. Therefore, when only one element is on, an aluminium surface would result in too much cooling of the heated area to the unheated area via conduction, which is not desirable.

The heating surface can comprise an inward facing surface formed at least partially of aluminium. In one example, the aluminium can be aluminium foil having a thickness of less than 0.2 mm and/or a thickness greater than 6 microns, 18 microns or 27 microns.

This is advantageous as it provides a means to conduct heat away from the heating elements and efficiently towards the surface of the heater.

The plurality of independent heating elements can have unequal surface areas.

This is advantageous as it allows a variety of distinct heat levels to be provided. For example, the infrared heater can have two heating elements, the first heating element occupying 40% of the heater surface area and the second heating element occupying 60% of the heater surface area. This allows the infrared heater to provide heating from 40%, 60%, or 100% of its surface area and thus provides three heating levels.

Each of the plurality of independent heating elements can have a Watt density of 0.09 to 0.1 Watts per cm².

This is advantageous as it provides a way to achieve the surface temperature required for efficient emission of infrared energy. If a heating element is operating outside of this range, for example if there is too little power over a surface area, the temperature of the surface will not be high enough to efficiently produce infrared heat. Alternatively, if too much power is provided to an area, the surface temperature is unnecessarily high relative to the required overall operating temperature of the heater. This can result in one area of the infrared heating panel becoming too hot and another too cool. Therefore, the target watt density of 0.09-0.1 W/cm² should be achieved by each individual heating element. Depending on the required operating temperature of the heater, the same Watt density can be achieved across all the heating elements.

The Watt density of each of the plurality of independent heating elements can be higher in areas closest to an external edge of the infrared heater.

This is advantageous as the outer edges of the infrared heater can be colder and are subject to conduction to the rear casing of the heater. Therefore, by providing a higher density of heating element in these areas, the temperature can be raised in regions which may otherwise be cooler than the centre of the infrared heater.

Each of the plurality of heating elements can comprise wiring arranged in an undulating line or spiral pattern for example.

This is advantageous as it provides an arrangement for the heating elements which maintains the required Watt density and can fit the area of the infrared heater available.

The heating wire can form a rectangular shape. The rectangular shape can be a block area and/or can be a rectangular outline. This provides an efficient arrangement of the heating elements to produce the desired Watt density.

The plurality of independent heating elements can be coplanar and can have a shared centre point. In other words, the independent heating elements can be concentric, for example, the heating elements can have a rectangular perimeter and be arranged such that a heating element with a smaller surface area can fit within the perimeter of a larger surface area heating element.

This arrangement is advantageous as it reduces wasted space on the front facing panel in systems where only one heating element is powered.

The emission surface is planar and externally facing.

This is advantageous as it allows the infrared heater to have a minimal depth between the external surface and a supporting structure. By providing the emission surface at an external face, the radiant heat can efficiently spread into large areas, such as rooms within houses.

The plurality of independent heating elements can be positive temperature coefficient, PTC, effect elements. The plurality of heating elements can be cupronickel, CuNi.

This is advantageous as PTC wires allow current to flow better at lower temperatures than at high temperatures. As the current is initially increased, the rated power of the panel can be briefly exceeded to produce heat very quickly while the resistance (which produces the heat) also increases quickly. A state of equilibrium can then be reached where current cannot flow any more at a given temperature and resistance as the panel reaches its rated power and operating temperature. The effect of this is, firstly, the heater warms up faster relative to non-PTC wires. This improves the “Dynamic Factor” (DF) of the heater, which is a measure of radiant efficiency. Secondly, PTC elements can be safe and reliable wiring because the effect makes an overheat condition difficult once maximum resistance is reached as the power consumption drops.

The rear surface can comprise a layer of insulation and can further comprise a reflective surface.

This is advantageous because it increases the overall efficiency of the infrared panel by reducing the radiant heat lost to the rear of the panel. Insulation, such as Rockwool insulation, impedes rearwards heat loss as well as forming a firewall inside the heater (Flammability Class A1 material). This is also a natural material and does not contain polymer or other man-made fibres.

By providing a reflective surface, the rear enclosure of the heater can be made of annealed stainless steel. This provides reflection for any remaining energy escaping to the rear of the heater. In turn, this results in more heat being radiated from the front of the panel.

The rear surface can be planar.

This is advantageous as it allows the infrared heater to sit closely to the surface it is placed on or secured to.

The infrared heater can further comprise a controller configured to operate the plurality of heating elements, wherein the controller can be connected to the infrared heater physically and/or wirelessly.

This can provide a means to remotely control the infrared heater.

The infrared heater can be configured to be powered by a mains connection.

According to a second aspect of the present invention there is provided a method of operating an infrared heater according to the first aspect, the method comprising: receiving a target temperature and a threshold temperature; detecting a temperature external to the infrared heater; initiating all of the plurality of independent heating elements when the detected temperature is below the threshold temperature and the target temperature; initiating one of the plurality of independent heating elements when the detected temperature is above the threshold temperature and below the target temperature.

This is an advantageous method because it allows a more consistent temperature to be achieved as the infrared heater can be controlled to provide different heating levels. Therefore, when the threshold temperature is met, the infrared heater can be controlled to provide less infrared emission and thus less heat so that a target temperature can be maintained more consistently.

### BRIEF DESCRIPTION OF THE DRAWINGS

Embodiments of the invention will now be described, strictly by way of example only, with reference to the accompanying drawings, of which:

FIG. 1 is a schematic representation of an infrared heating system;

FIG. 2 is a schematic representation of an infrared heating panel;

FIG. 3A is a schematic representation of independent infrared heating elements;

FIG. 3B is a schematic representation of wiring which forms independent infrared heating elements; and

FIG. 4 is an exemplary method of using an infrared heating panel.

### DETAILED DESCRIPTION

By way of a non-limiting overview, embodiments of the invention relate to an infrared heating operable to provide varying heating levels. It is an established principle of human comfort that the optimum comfort temperature is the average of air temperature and mean radiant (i.e., background environment) temperature and not just air temperature and not just radiant temperature. The average of air temperature and MRT is referred to as “operative temperature”.

Most domestic heaters only heat air (i.e., are convection heaters) and background radiant heat only accumulates ineffectively and slowly, meaning that for the majority of their operating time, most domestic heaters have to overheat the air to compensate for inadequately warming the radiant environment. This wastes energy and is not particularly comfortable.

Radiant infrared Panel heaters exist which primarily emit radiant heat to people and objects. These are capable of correcting the inadequacies of convection-based heating by increasing the mean radiant temperature of an environment and not requiring the air to be warmed up so much. Indeed, studies show that when the Mean Radiant Temperature (MRT) of a room reaches approximately 17° C., occupants typically feel comfortable at an air temperature of 19° C., allowing an overall reduction in air temperature by 1-2° C. from the generally accepted norm of 21° C., while maintaining human comfort, potentially saving 10-12% in energy compared to convection heaters.

The class of heaters able to do this is defined by International Standards (IEC60675) as “Low Temperature Infrared Heaters” and must possess the following qualities:
The heating surface must maintain a temperature between 40° C. and 200° C.
A measured Radiant Efficiency of no less than 40% (indicating the proportion of total power that is radiant rather than convective or conductive).
To be sufficiently “Radiant” the principal heating surface must exhibit a temperature rise of greater than 75° C.

Most such infrared heaters typically operate with a surface temperature between 85-110° C., which emits a comfortable wavelength of far-infrared heat at around 5-6 microns and a power level of roughly 1 kW/m². At this surface temperature, people within 2-3 meters of the panel experience pleasant warmth, with radiant heat benefits extending up to 4 meters. Higher surface temperatures can be uncomfortably intense, while lower temperatures reduce radiant efficiency. Higher surface temperature panels are more appropriate for installation on ceilings in dwellings with relatively high ceilings where the occupants will be further away from the panels.

The standard operating mode for infrared panel heaters involves providing full power to the heating elements until the desired air temperature is reached, followed by cutting power (fully off) to the heating elements once that temperature is achieved. As the region around the infrared heater cools, the ambient temperature falls below the desired level, prompting the heating elements to activate again to compensate for heat loss from the room.

The drawback of this approach is that when the radiant heat source is turned off after reaching the desired room temperature, occupants lose the benefits of radiant heat. This sensation is similar, although less extreme, to a cloud covering the sun on a winter day when the temperature of the environment then becomes noticeably colder than it was when receiving the heat from the sun. Consequently, the room's overall temperature still needs to be set higher than necessary for comfort had the radiant heat source still been present.

In an ideal scenario, therefore, an infrared heater would operate at full power to rapidly and comfortably warm up the room to reach the desired operative temperature. When the ambient temperature is relatively close to the desired operative temperature, the infrared heater would then not need to continue operating at full power to achieve the desired warm-up. However, instead of then turning off completely (with lower air temperature and rapidly reducing radiant temperature), the ideal infrared heater would reduce its power and therefore maintain the balance between the lower air temperature and benefits of direct radiant heat: optimal conditions for human comfort and very efficient use of energy. It can still be turned back on fully, if need be, or turned fully off if need be but by providing this interim power state, is a vital missing feature in being able to keep air temperatures low enough to be energy saving and radiant temperature high enough for comfort.

Reducing the voltage or power to the heater as it approaches the desired setpoint temperature to achieve precise temperature modulation may seem like an obvious way to achieve this power reduction. However, reducing power or voltage reduces the overall Watt density of the surface, lowering its overall temperature, and consequently reducing the radiant efficiency of the panel relative to its convection output, disqualifying it as a radiant heater and failing to deliver the ongoing radiant heat required. As such, it is not possible to take a known infrared panel and just reduce its power, as it would stop being an infrared heater.

To address this issue, embodiments of the invention can maintain the required radiant effect by fully heating specific sub-areas of the total surface of the heating panel when reduced power is required or fully heating the whole surface area when full power is required. This allows those sub-areas in partial-power mode to maintain the required temperature and Watt density to keep producing radiant heat in this power saving, comfort optimising, partial power mode.

In summary, embodiments of the invention provide:
A variable power Infrared Heater that remains within the “Low Temperature Infrared Heater” class throughout its variable power range, maintaining a surface temperature between 85-110° C. in the surfaces with power applied, thereby providing both full and partial radiant heating.
The capability to sufficiently heat radiant and operative temperatures to the required setpoint which can be 1-2 C below the normal setpoints required by Central heating and therefore achieve energy efficiencies
The preservation of the radiant sensation even after reaching the setpoint, which allows for lower air temperatures and maintains optimum human comfort
The ability to modulate across full and partial power modes with suitable controls to maintain optimal comfort while consuming less power compared to traditional “full power only” Infrared heaters or standard convection/central heaters.

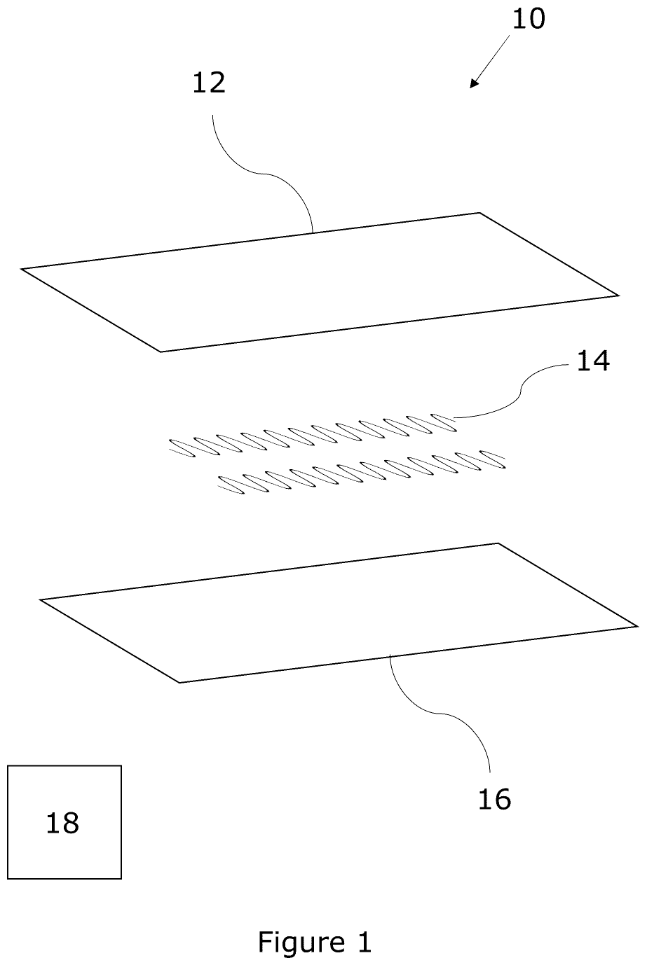

FIG. 1 shows an exemplary arrangement of an infrared heating panel 10 including an arrangement of an infrared emission surface 12, a rear surface 16, and a plurality of independent heating elements 14 shown in an expanded view. The infrared heating panel 12 can have a rectangular horizontal cross section. The layers 12, 14, 16 of the heating panel can each have substantially the same footprint and external perimeter. The infrared heating panel 10 is assembled such that the layers 12, 14, 16 are generally aligned so that the horizontal cross section of the infrared panel 10 is substantially the same as an individual layer. The cross-sectional area of the infrared heater can be 0.18 m² to 1 m², which provides about 200 watts at the lower end of the range to 1250 watts at the top end.

The infrared heating panel can be arranged to connect to a controller 18 via a wired or wireless connection. The controller 18 can be used to operate the independent heating elements 14.

The infrared emission surface 12 can be generally planar in order to minimise the overall depth of the infrared panel. The emission surface 12 can be between 0.9 mm to 1.2 mm in depth. The infrared emission surface 12 can provide edges arranged to connect to the rear panel 16 and thereby encase the heating elements 14. The infrared emission surface can be formed of a conductive metal, such as aluminium or steel.

The infrared heating elements 14 can be generally planar and arranged between the emission surface 12 and the rear surface 16. The heating elements 14 are at least two distinct elements. The distinct heating elements 14 are electrically arranged such that they can be operated individually. The heating elements can be arranged whereby the Neutral (or Live 2) pole may be common to all the elements, but the Live (or Live 1) pole is individual to each element and is activated per element. This enables the heating elements to be independently controlled so that each heating element can emit infrared radiant heat without other heating elements also emitting infrared radiant heat. The heating elements can also operate independently at the same time so that all or a portion of the heating elements emit infrared radiant heat.

The heater elements 14 can be “Positive Temperature Coefficient” (PTC) effect elements. For example, cupronickel, CuNi, can be used. Other PTC alloys are suitable for use. The PTC elements are arranged to provide heat when current flows. The elements provide heat to the emission surface which then radiates infrared heat when the emission surface temperature rises by more than 75° C. from cold. The term “from cold” in the context of the claimed invention can for example mean from a temperature of 8° C. to 15° C. Due to the nature of PTC effect elements, the electrical resistance within the elements increases with temperature. Therefore, once connected to an electrical source, the heating elements can increase in temperature until a state of equilibrium is reached where current cannot flow any more at a given temperature and resistance.

The rear surface 16 can be generally planar. The rear surface can be formed of a metal, such as aluminium or steel. The rear surface 16 can be provided with a means to mount the infrared panel on a surface, such as a wall or ceiling. For example, a mounting bracket formed of galvanised steel can be arranged centrally to secure the infrared panel to the surface. Alternatively feet can be provided for smaller heaters to make them freestanding. The rear panel 16 can provide edges arranged to connect to the infrared emission surface 12 and thereby encase the heating elements 14.

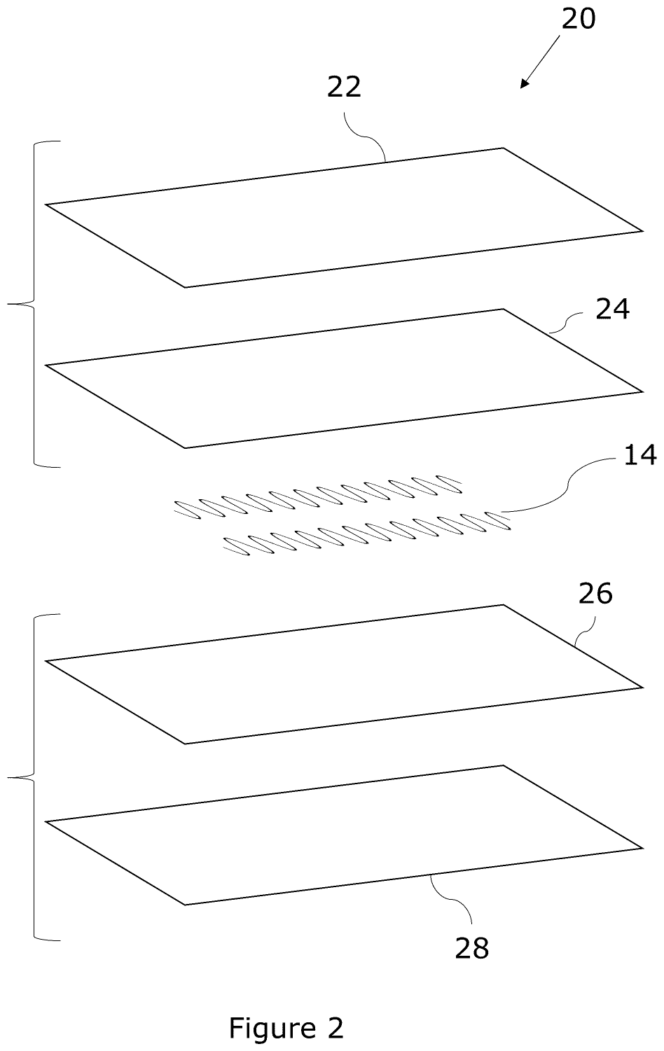

FIG. 2 shows an exemplary arrangement of an infrared heating panel 20 including a further arrangement of an infrared emission surface 12, a rear surface 16, and a plurality of independent heating elements 14 shown in an expanded view. Infrared heating panel 20 is substantially similar to the previously described infrared heating panel 10 and therefore the following description only references the differences.

The infrared emission surface 12 can be formed from a steel surface 22 arranged to face externally, away from the heating elements 14. The steel surface 22 can be formed from cold rolled mild steel protected with a high temperature resistant powder coating. The steel surface 22 can be arranged to operate in the temperature range of 85° C. to 110° C. This arrangement provides an external surface which maintains infrared heat local to the heating elements so that the infrared heat is not dispersed over the entire face of the infrared heater when select independent heating elements are being operated. The infrared emission surface 12 can further include an aluminium surface 24 arranged internally such that the aluminium surface 24 is proximate to the heating elements 14. This arrangement provides a surface which conducts heat away from the heating elements (via the aluminium surface 24) and towards the external surface of the infrared heating panel.

The rear panel 16 can be formed from an insulating layer 26 which demonstrates high thermal efficiency. This arrangement can reduce the amount of heat lost to the rear of the panel which is advantageous when the infrared panel is mounted on a surface as it reduces the heat lost to a region which does not require heating and maximises forwards heat projection and therefore radiant efficiency. The insulation layer 26 can include Rockwool™ insulation, which impedes rearwards heat loss as well as forming a firewall inside the heater (Flammability Class A1 material). The insulation layer 26 can be a natural material, not containing a polymer or other man-made fibres.

The rear panel 16 can further include a radiant reflective layer 28 which can direct energy which has escaped past the insulating layer 26 away from the rear of the infrared panel. The presence of a reflective rear panel can reduce the temperature of the back face of the panel by 20% compared to a non-reflective surface. The radiant reflective surface can be made from steel, specifically, annealed stainless steel.

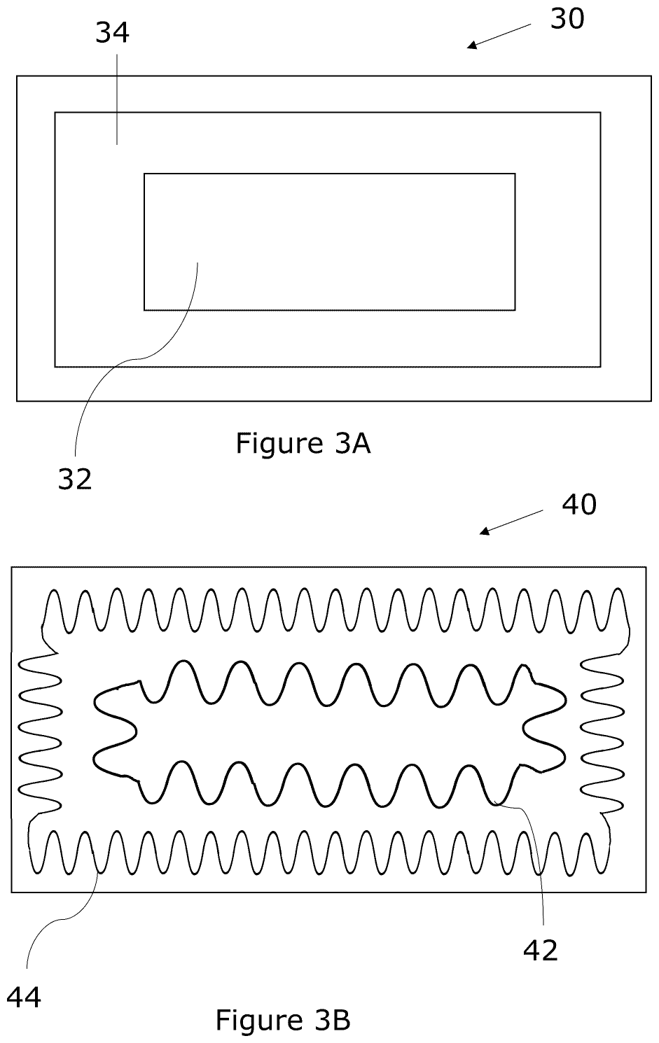

FIG. 3A shows an exemplary schematic arrangement of independent heating elements 32, 34 within an infrared heating panel 30. Infrared heating panel 30 is substantially similar to the previously described infrared heating panels 10, 20 and therefore the following description only references the differences.

A first heating element 32 can be arranged within a second heating element 34. Alternative arrangements can include heating elements adjacent each other. Further heating elements may be present. In the example presented in FIG. 3A, the first heating element 32 has a smaller surface area compared to the second heating element 34. Therefore, the first heating element can be considered a lower power heating element when compared to the second heating element 34. In one example, the first heating element 32 can occupy 40% of the surface area of the heating element layer of the infrared heating panel 30 and the second heating element can occupy 60% of the surface area of the heating element layer of the infrared heating panel 30. Alternatively, the surface area ratio can be 50% and 50%, 55% and 45%, or 30% and 70%.

FIG. 3B shows an exemplary arrangement of the wiring 42, 44 which form the independent heating elements 32, 34. Again, infrared heating panel 40 is substantially similar to the previously described infrared heating panels 10, 20, 30 and therefore the following description only references the differences.

The wiring 42, 44 can be PTC effect elements. The wiring 42, 44 can be arranged in any suitable arrangement which achieves a desired Watt density of 0.09-0.1 Watt/cm². For example, the wiring can be arranged in a generally sinusoidal shaped line which fills the desired surface area. The wiring can be arranged such that a single row of wiring fills the surface area of each heating element. Alternatively or additionally, the wiring can be arranged such that the surface area of each heating element is made up of multiple rows of wiring. The density of the wiring in areas closer to the perimeter of the infrared heater 40 can be greater than that in areas further from the perimeter. This can help to maintain temperature at the edges of the panel which may experience greater heat loss than more central areas. It is important for each independent heating element to maintain a temperature high enough for infrared heat to radiate from the emission surface.

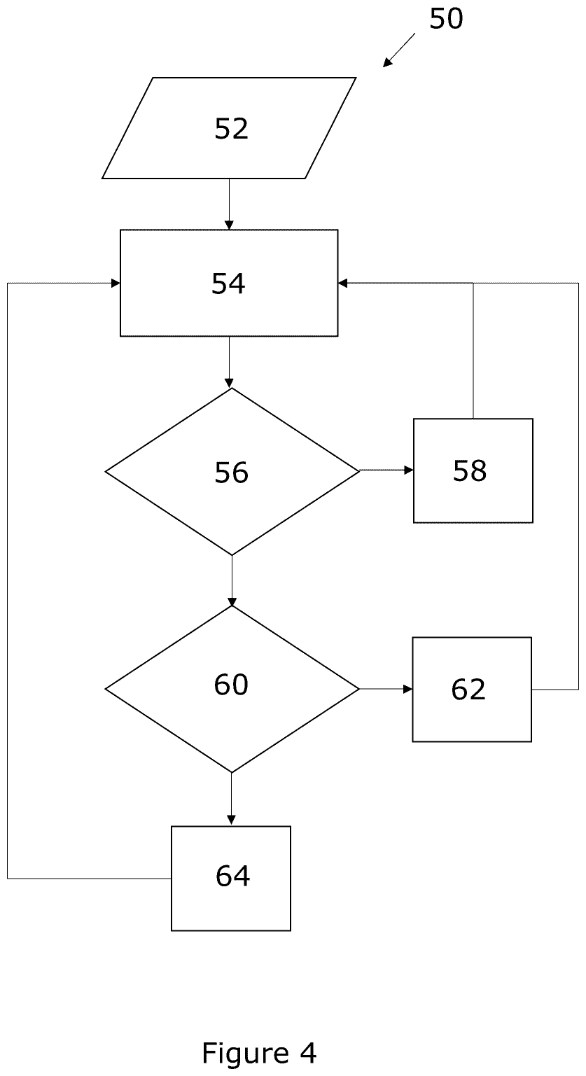

FIG. 4 shows an exemplary operation 50 of an infrared heating panel 10, 20, 30, 40. At step 52, a target temperature and threshold temperature are received at a controller 18. The target temperature is the desired room temperature. This temperature can be set or selected by a user. The threshold temperature is a temperature lower than the target temperature which can be selected by a user or set by the controller. For example, a user may select a room temperature of 21° C. The target temperature is then 21° C. The user or controller may then set a threshold temperature to be 1° C. less than the target temperature. The threshold temperature is then 20° C.

At step 54, a temperature measurement of the space to be temperature controlled is taken or provided to the controller. Therefore, this temperature measurement provides the current temperature of the space. This can be detected using a known temperature sensor such as an ambient air temperature sensor or a black bulb sensor.

At step 56, the controller compares the temperature detected 54 to the threshold temperature. If the detected temperature is lower than the threshold temperature, the controller 18 provides a signal to the infrared heating panel 10, 20, 30, 40 to provide and/or maintain power 58 to all heating elements so that substantially 100% of the surface area of the heating elements are being operated. This provides a maximum amount of radiant heat that the infrared heating panel can provide. Whilst all of the independent heating elements are powered, the method returns to step 54 to detect the current temperature.

If, at step 56, it is determined that the detected temperature is at or above the threshold temperature, the method moves on to step 60. At step 60, the controller compares the detected temperature at step 54 with the target temperature. If the detected temperature is below the target temperature, the controller provides a signal to the infrared heating panel to power and/or maintain power 62 to a portion of the independent heating elements. For example, if two independent heating elements are provided, at step 62, one element would be on and provide radiant heat and the other would be off and provide no radiant heat. The method then returns to step 54 and determines the current temperature.

If, at step 56 or 60, it is determined that the detected temperature is above the target temperature, the controller provides a signal to the infrared heating elements to turn off and provide no radiant heat 64. The method then returns to step 54 and determines the current temperature.

Therefore, the method 50 provides constant monitoring of the current temperature within a space which is to be temperature controlled and a means to adjust the temperature of the space.

Additionally, the method 50 can include steps to determine which heating element is most suitable for operation at step 62. For example, if it is determined that the current temperature detected at step 54 is 0.3° C. less than the target temperature, the smallest surface area heating element 32 may be powered to provide radiant heat. If it is determined that the current temperature detected at step 54 is 0.8° C. less than the target temperature, the largest surface area heating element 34 may be powered to provide radiant heat. This provides fine control over the radiant energy produced within the temperature range between the threshold temperature and the target temperature.

The user may choose the radiant heat or power level at any stage of the example method 50. For instance, the user could overwrite the method by selecting a radiant heat level regardless of temperature measured. For example, the user may select a level from 1, 2, or 3 where level 1 relates to powering the smallest surface area heating element only, level 2 relates to powering the largest surface area heating element only, and level 3 relates to powering both the smallest and largest surface area heating elements together.

It should be noted that there is likely to be a lag between a heating element being powered and the detected temperature rising and/or meeting the threshold and/or target temperature. The lag affects the “Dynamic Factor” (DF) of the heater. The dynamic factor is a measure of radiant efficiency, being the measured radiant efficiency of the heater in %, divided by the warmup time in minutes. The warmup time is defined by IEC as the time taken from cold for the heater to reach ⅔ of the temperature reached in steady-state operation (a measured period of 10 minutes of operation in which a deviation of +/1 K (1° C.) of output temperature occurs). For example, a 70% radiant heater with a warmup time of 7 minutes would have a dynamic factor of 10. A higher dynamic factor is desirable because the heater is being more radiantly efficient and more radiantly reactive. Enhancing radiant efficiency and responsiveness reduces energy consumption (by not wastefully heating air) and improving comfort (also by not wastefully heating air).

The disclosed infrared heater and method of operation is suitable for use in enclosed spaces which require indoor heating such as rooms within a home.

Although the invention has been described above with reference to one or more preferred embodiments, it will be appreciated that various changes or modifications can be made without departing from the scope of the invention as defined in the appended claims. The word “comprising” can mean “including” or “consisting of” and therefore does not exclude the presence of elements or steps other than those listed in any claim or the specification as a whole. The mere fact that certain measures are recited in mutually different dependent claims does not indicate that a combination of these measures cannot be used to advantage.

What is claimed is:

1. An infrared heater comprising:
an infrared emission surface;
a rear surface; and
a plurality of independent heating elements arranged between the infrared emission surface and rear surface, wherein the plurality of independent heating elements operate on independent circuitry such that each heating element can be independently controlled, and wherein the independent heating elements are configured such that the infrared emission surface has an operating temperature of 85° C. to 110° C.

2. The infrared heater according to claim 1, wherein each of the plurality of independent heating elements is configured to operate concurrently and/or individually.

3. The infrared heater according to claim 1, wherein the infrared emission surface comprises an outward facing surface formed at least partially of steel.

4. The infrared heater according to claim 1, wherein the infrared emission surface comprises an inward facing surface formed at least partially of aluminium.

5. The infrared heater according to claim 1, wherein the plurality of independent heating elements have unequal surface areas.

6. The infrared heater according to claim 1, wherein each of the plurality of independent heating elements have a Watt density of 0.09 to 0.1 Watts per cm².

7. The infrared heater according to claim 1, wherein the Watt density of each of the plurality of independent heating elements is greater in areas closest to an external edge of the infrared heater.

8. The infrared heater according to claim 1, wherein each of the plurality of heating elements comprises wiring arranged in a non-linear arrangement.

9. The infrared heater according to claim 8, wherein the heating wire forms a rectangular or spiral shape.

10. The infrared heater according to claim 1, wherein the plurality of independent heating elements are coplanar and have a shared centre point.

11. The infrared heater according to claim 1, wherein the infrared emission surface is planar and externally facing.

12. The infrared heater according to claim 1, wherein the plurality of independent heating elements are positive temperature coefficient, PTC, effect elements.

13. The infrared heater according to claim 1, wherein the rear surface comprises a layer of insulation and a reflective surface.

14. The infrared heater according to claim 1, wherein the rear surface is planar.

15. The infrared heater according to claim 1, further comprising a controller configured to operate the plurality of heating elements, wherein the controller is connected to the infrared heater physically and/or wirelessly.

16. A method of operating an infrared heater according to claim 1, the method comprising:
receiving a target temperature and a threshold temperature;
detecting a temperature external to the infrared heater;
initiating all of the plurality of independent heating elements when the detected temperature is below the threshold temperature and the target temperature;
initiating one of the plurality of independent heating elements when the detected temperature is at or above the threshold temperature and below the target temperature.
